(19) United States
(12) Patent Application Publication
(10) Pub. No.: US 2026/0289694 A1
(43) Pub. Date: Sep. 24, 2026

(54) UTILITY POLE MANAGEMENT TASK ASSISTANCE METHOD AND UTILITY POLE MANAGEMENT TASK ASSISTANCE SYSTEM

(71) Applicant: NEC CORPORATION, Tokyo (JP)

(72) Inventors: Kazuya TAKEDA, Tokyo (JP); Yuichiro KATO, Tokyo (JP)

(73) Assignee: NEC CORPORATION, Tokyo (JP)

(21) Appl. No.: 19/489,306

(22) PCT Filed: Jun. 13, 2023
(86) PCT No.: PCT/JP2023/021953

§ 371 Date: Dec. 2, 2025

(51) Int. Cl. G06Q 50/10; G06Q 30/0283; G06V 20/56; H04N 7/18

(52) U.S. Cl. CPC G06Q 50/10; G06Q 30/0283; H04N 7/18; G06V 20/56

(57) ABSTRACT

This utility pole management task assistance system comprises: a calculation unit that calculates the total cost of a task to be improved, on the basis of the number of utility poles located in a data collection target area and the cost required for confirming the sites of the utility poles, these items of data being acquired from a customer; an agreement formation unit that multiplies the total cost by a prescribed contribution rate, calculates an amount of improvement achieved by automation of a site image collection task, presents the improvement amount to the customer, and forms an agreement with the customer; an image collection unit that, after formation of an agreement with the customer, implements collection of site images captured using a moving object on which a camera is mounted; a matching unit that, on the basis of a utility-pole image included in the site image and utility-pole information recorded in a utility pole management ledger belonging to the customer, identifies a utility pole in the utility pole management ledger, the utility pole corresponding to the utility pole image; and a utility pole information provision unit that configures a utility pole management database in which the image of the utility pole captured using the mobile body is added to the data in the utility pole management ledger belonging to the customer and provides the utility pole management database to the customer.

### TECHNICAL FIELD

The present invention relates to a utility pole management task assistance method and a utility pole management task assistance system.

### BACKGROUND ART

Power companies all over Japan each perform an inspection task for utility poles. It is said that there are 20 million such utility poles in Japan. Meanwhile, workers who perform inspection and construction of these utility poles are aging and tend to decrease, and it is required to enhance the efficiency of the inspection task.

PTL 1 discloses an example of a patrol inspection system. According to PTL 1, in the patrol inspection system, an information terminal identifies a utility pole number of a utility pole through which the information terminal is to pass, using an image of a 360-degree camera and a global positioning system (GPS) function during patrol, and determines whether there is an anomaly in an inspection target facility of the utility pole, based on a detection result of an anomaly detection sensor. It is described that the information terminal transmits the inspection result stored in a storage unit and an image linked with position information at the time of capturing, to a management server in response to an instruction to end the patrol.

### CITATION LIST

### Patent Literature

PTL 1: JP 2019-32684 A

### SUMMARY OF INVENTION

### Technical Problem

As the information terminal of PTL 1, a car navigation mounted on a vehicle of a power company or a mobile terminal such as a smartphone or a tablet owned by an inspector is assumed. Therefore, it is necessary for the worker to go around the sites. In the future, it is presumed that the number of workers will further decrease and the workers will be aging, and drastic measures including utilization of external resources are required.

An object of the present disclosure is to provide a utility pole management task assistance method and a utility pole management task assistance system that can contribute to labor saving in a utility pole management task of a customer who manages utility poles.

### Solution to Problem

According to a first aspect, provided is a utility pole management task assistance method including calculating a total cost of a task to be improved, by using at least a number of utility poles located in a data collection target area and a cost required for confirming sites of the utility poles, these items of data being acquired from a customer who manages utility poles by using a utility pole management ledger, multiplying the total cost by a predetermined contribution rate, calculating an improvement amount achieved by automation of a site image collection task, and presenting the improvement amount to the customer, after formation of an agreement with the customer, implementing collection of site images by a moving object on which a camera is mounted, based on a utility pole image included in the site images and utility pole information recorded in the utility pole management ledger of the customer, identifying a utility pole in the utility pole management ledger relevant to the utility pole image, and configuring a utility pole management database obtained by adding the utility pole image captured by the moving object to data of the utility pole management ledger of the customer, and providing the obtained utility pole management database to the customer.

According to a second aspect, provided is a utility pole management task assistance system including a calculation unit that calculates a total cost of a task to be improved, by using at least a number of utility poles located in a data collection target area and a cost required for confirming sites of the utility poles, these items of data being acquired from a customer who manages utility poles by using a utility pole management ledger, an agreement formation unit that multiplies the total cost by a predetermined contribution rate, calculates an improvement amount achieved by automation of a site image collection task, presents the improvement amount to the customer, and forms an agreement with the customer, an image collection unit that, after formation of the agreement with the customer, implements collection of site images by a moving object on which a camera is mounted, a matching unit that, based on a utility pole image included in the site images and utility pole information recorded in the utility pole management ledger of the customer, identifies a utility pole in the utility pole management ledger relevant to the utility pole image, and a utility pole information provision unit that configures a utility pole management database obtained by adding the utility pole image captured by the moving object to data of the utility pole management ledger of the customer, and provides the obtained utility pole management database to the customer.

### Advantageous Effects of Invention

According to the present disclosure, it is possible to contribute to labor saving in a utility pole management task of a customer who manages utility poles.

### BRIEF DESCRIPTION OF DRAWINGS

FIG. 1 is a diagram illustrating a configuration of an example embodiment of the present disclosure.

FIG. 2 is a flowchart illustrating an operation of an example embodiment of the present disclosure.

FIG. 3 is a flowchart illustrating an operation of an example embodiment of the present disclosure.

FIG. 4 is a flowchart illustrating an operation of an example embodiment of the present disclosure.

FIG. 5 is a diagram illustrating a configuration of the present disclosure.

FIG. 6 is a diagram illustrating a detailed configuration of an assistance system of the present disclosure.

FIG. 7 is a diagram representing an overall operation of a configuration of the present disclosure.

FIG. 8 is a diagram for explaining a detailed operation of a configuration of the present disclosure.

FIG. 9 is a diagram illustrating a detailed configuration of another assistance system of the present disclosure.

FIG. 10 is a diagram for explaining a detailed operation of another configuration of the present disclosure.

FIG. 11 is a diagram illustrating a configuration of a computer constituting an information processing apparatus of the present disclosure.

### EXAMPLE EMBODIMENT

First, an outline of example embodiments of the present disclosure will be described with reference to the drawings. Reference numerals assigned in the drawings of the outline are assigned to each element for convenience as an example for the sake of convenience to facilitate understanding, and are not intended to limit the present disclosure to any mode shown in drawings. An individual connection line between blocks in the drawings and the like referred to in the following description includes both bidirectional and unidirectional. A unidirectional arrow schematically indicates a flow of a principal signal (data), and does not exclude bidirectionality. A program is executed by a computer apparatus, and the computer apparatus includes, for example, a processor, a storage device, an input device, a communication interface, and a display device as necessary. The computer apparatus is configured to be communicable with devices (including a computer) inside or outside the device via a communication interface in a wired or wireless manner. Although there are ports and interfaces at connection points of input and output of each block in the relevant drawings, illustration of the port or interface is omitted.

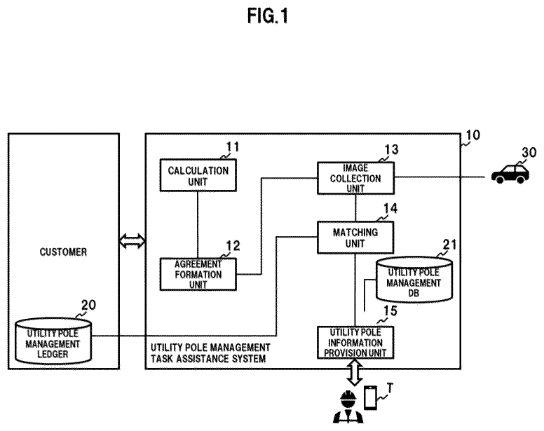

In an example embodiment, as illustrated in FIG. 1, the present disclosure can be enabled by a utility pole management task assistance system 10 including a calculation unit 11, an agreement formation unit 12, an image collection unit 13, a matching unit 14, and a utility pole information provision unit 15. More specifically, the calculation unit 11 calculates a total cost of a task to be improved, by using at least the number of utility poles located in a data collection target area and a cost required for confirming sites of the utility poles, which have been acquired from a customer who manages utility poles by using a utility pole management ledger 20. The total cost of the task to be improved can be calculated, for example, by multiplying the number of utility poles by the cost required for confirming the site of one utility pole. A management cost or the like may also be added to the total cost of the task to be improved. The utility pole management ledger is a ledger in which a type, a position, and the like of a utility pole are registered for each utility pole identified by a utility pole number or utility pole identification information. A database or the like in which a type, a position, and the like of a utility pole are registered for each utility pole for the purpose of, for example, managing utility poles can also be used as the utility pole management ledger.

The agreement formation unit 12 multiplies the total cost by a predetermined contribution rate to calculate an improvement amount achieved by automation of the site image collection task, presents the calculated improvement amount to the customer, and forms an agreement with the customer. The calculation unit 11 and the agreement formation unit 12 described above can also be enabled by an estimation server published on the Internet. In this case, after accepting inputs of the number of utility poles located in the data collection target area and the cost required for confirming the sites of the utility poles, the estimation server conducts multiplication by a predetermined contribution rate and presents an improvement amount achieved by automation of the site image collection task to form an agreement. In a case of calculating a more advanced improvement amount, a person in charge may visit the customer to conduct a hearing, and the improvement amount achieved by automation of the site image collection task may be estimated based on detailed information.

After formation of the agreement with the customer, the image collection unit 13 implements collection of site images by a moving object on which a camera is mounted. Specifically, when receiving the site images from the designated moving object, the image collection unit 13 sends the received site images to the matching unit 14 and requests the matching unit 14 to collate the site images against data of the utility poles registered in the utility pole management ledger 20. A vehicle, an unmanned aerial vehicle (drone), or the like is assumed as the moving object on which the camera is mounted. As a camera mounted on these moving bodies, a dashboard camera, a built-in camera of a smartphone, or the like can also be used. In a case where these devices are used, there is an advantage that captured images can be transmitted using a communication function of these devices.

Based on a utility pole image included in the site images and utility pole information recorded in the utility pole management ledger of the customer, the matching unit 14 identifies the utility pole in the utility pole management ledger relevant to the utility pole image. The process of identifying the utility pole can be implemented, for example, by checking position information (latitude and longitude) on a utility pole recorded in the utility pole management ledger of the customer against imaging position information attached to a site image. In a case where the two positions are close to each other as a result of the check, the matching unit 14 determines that a utility pole included in the site image that is identical to a utility pole recorded in the utility pole management ledger of the customer has been found. The method for determining the identity between the utility poles is not limited to this method. For example, a feature of an image of a utility pole captured in advance may be compared with a feature of an image of a utility pole appearing in a site image collected by the image collection unit 13, and the identity between the two utility poles may be verified based on the identity between their shapes, the utility pole numbers obtained by character recognition, or the like.

The utility pole information provision unit 15 configures a utility pole management database 21 (hereinafter, referred to as a “utility pole management DB 21”) obtained by adding the utility pole image captured by the moving object to the data of the utility pole management ledger 20 of the customer and provides utility pole information with the site image in response to a request from the customer.

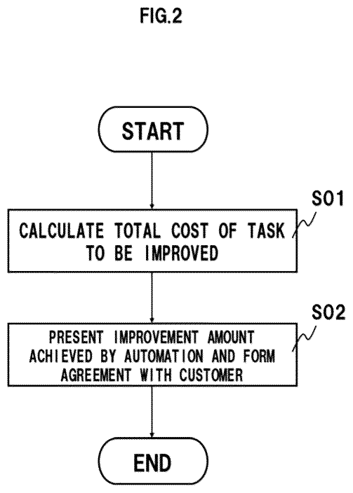

The utility pole management task assistance system 10 (hereinafter, abbreviated as an “assistance system 10”) configured as described above operates as follows. First, the assistance system 10 calculates a total cost of a task to be improved, by using the number of utility poles located in a data collection target area and a cost required for confirming sites of the utility poles, which have been input (step S01 in FIG. 2).

Next, the assistance system 10 multiplies the total cost by a predetermined contribution rate to calculate an improvement amount achieved by automation of the site image collection task, presents the calculated improvement amount to the customer, and forms an agreement with the customer (step S02 in FIG. 2). Here, the contribution rate is a rate for converting work man-hours that can be reduced by automation of the site image collection task, into an amount of money. For example, when the total cost of the task to be improved is assumed to be one billion yen and the contribution rate is assumed to be 50%, the improvement amount achieved by automation of the site image collection task is 500 million yen. The customer will compare this improvement amount with the service usage fee to examine and decide whether to use the assistance service for the site image collection task provided by the assistance system 10.

The contribution rate is desirably adjusted to an appropriate value according to the dimensions of the service target area and the difficulty level in confirming the actual site. For example, in a case where the service target area is wide, the work man-hours of the customer also rise accordingly, and thus, a high value can be set as the contribution rate. On the other hand, in a case where the service target area is narrow, the work man-hours of the customer are lowered, and thus, a small value can be set as the contribution rate. The contribution rate may also be increased or decreased in consideration of regional characteristics in addition to whether the service target area is wide or narrow. For example, in an area that requires a high inspection frequency (because, for example, there is a main road, there is a large traffic volume, or deterioration is fast due to salt damage caused by seaside location), it is desirable to set the contribution rate to a value higher than those in other areas. Similarly, in a snowy area or a cold area, it is desirable to set the contribution rate to a value higher than those in other areas since it takes cost to confirm the site (to go to the actual site). Furthermore, in an area with a large traffic volume, the efficiency of confirming the site is degraded, for example, due to being stuck in traffic congestion, and thus, it is desirable to set the contribution rate to a value higher than those in other areas. Moreover, it is also assumed that the collected site image is not clear due to snow accumulation or icing depending on the season. In this case, since the work man-hours of the customer that can be reduced are lowered, the contribution rate may be set to a low value. In this manner, by appropriately setting the contribution rate, formation of an agreement with the customer can be easily established.

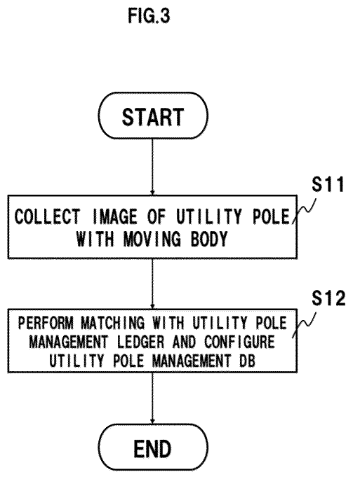

After formation of the agreement with the customer, the assistance system 10 implements collection of site images by a moving object on which a camera is mounted (step S11 in FIG. 3). Then, the assistance system 10 performs matching between information in the utility pole management ledger and the image of a utility pole appearing in the collected site images and configures the utility pole management DB 21 (step S12 in FIG. 3). The assistance system 10 repeats the operations in steps S11 and S12 described above until a predetermined number of utility poles are identified.

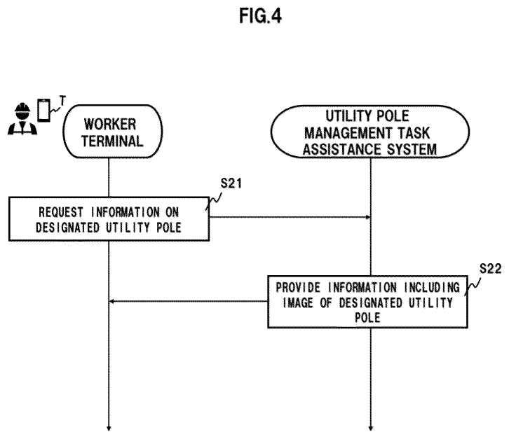

After that, in a case where a worker of the customer requests information on a designated utility pole by using a terminal T (step S21 in FIG. 4), the assistance system 10 retrieves information including an image of the designated utility pole from the utility pole management DB 21 and transmits the retrieved information to the terminal T of the worker (step S22 in FIG. 4).

As described above, according to the present example embodiment, labor saving in the utility pole management task can be promoted under the agreement with the customer. The reason for this is that a mechanism has been built in which an agreement is made after an economic effect of the customer is indicated, then a moving object is caused to capture a site image, and the site image can be gathered in the utility pole management DB.

### First Example Embodiment

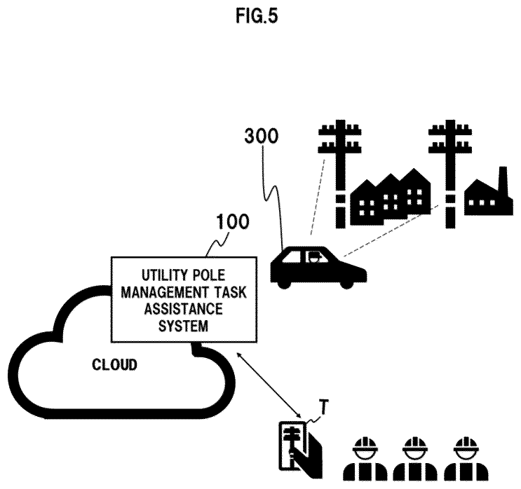

Subsequently, a first example embodiment in which the site image is collected using a vehicle as a moving object will be described. FIG. 5 is a diagram illustrating a configuration of the present disclosure. Referring to FIG. 5, a configuration including a utility pole management task assistance system 100 (hereinafter, abbreviated as an “assistance system 100”) placed on a cloud computing infrastructure, a patrol vehicle 300 that transmits an image to the assistance system 100, and a terminal T of a worker who is provided with a site image from the assistance system 100 is illustrated.

The patrol vehicle 300 may be a vehicle handled by the administration entity of the assistance system 100, but may be a vehicle of a cooperation company contracted with the administration entity of the assistance system 100, a local government patrol car, or a vehicle of a general user.

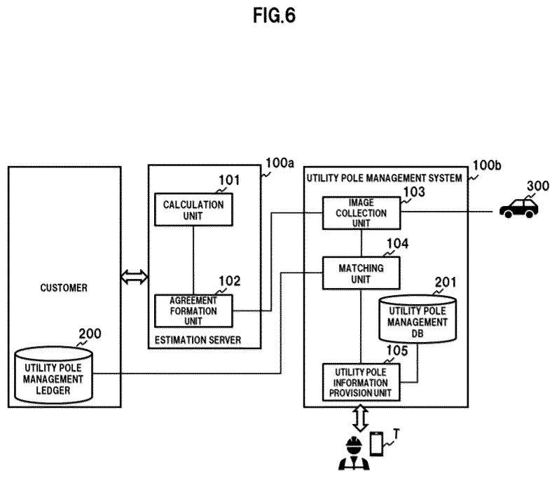

FIG. 6 is a diagram illustrating a detailed configuration of the assistance system 100 of the present disclosure. Referring to FIG. 6, the utility pole management task assistance system 100 having a configuration including an estimation server 100a and a utility pole management system 100b is illustrated.

The estimation server 100a includes a calculation unit 101 and an agreement formation unit 102. The calculation unit 101 presents a registration form requesting the terminal of the customer to transmit information necessary for estimation and calculates a total cost of a task to be improved, based on the content input into the presented registration form. In a case of the utility pole management task, the total cost of the task to be improved can be calculated based on the number of utility poles located in the data collection target area and a cost required for confirming the sites of the utility poles. The method for calculating the total cost of the task to be improved is not limited to this method. For example, the total cost of the task to be improved can also be calculated by classifying the utility poles according to the difficulty level in confirming the sites and using the number of utility poles for each class and the site confirmation cost for each class.

The agreement formation unit 102 multiplies the total cost by a predetermined contribution rate to calculate an improvement amount achieved by automation of the site image collection task, presents the calculated improvement amount to the customer, and forms an agreement with the customer. As a method for forming an agreement with the customer, it is possible to adopt a form in which an order button and a mail form activation button are placed on a screen displaying the improvement amount achieved by automation of the site image collection task and the customer operates these buttons. An “estimation condition change” button may also be placed in such a way that the customer can vary the estimation conditions, and re-estimation may be enabled by varying a numerical value on the registration form.

The utility pole management system 100b includes an image collection unit 103, a matching unit 104, a utility pole information provision unit 105, and a utility pole management database 201 (hereinafter, referred to as a “utility pole management DB 201”). After formation of the agreement with the customer, the image collection unit 103 implements collection of site images by the patrol vehicle 300 on which a camera and a positioning means are mounted. As a positioning means of the patrol vehicle 300, a global positioning system (GPS) or a real time kinematic (RTK) can be used. Then, the patrol vehicle 300 travels along a preset course or the like and captures a surrounding image, using the mounted camera. The patrol vehicle 300 then transmits the captured image to the assistance system 100. The patrol vehicle 300 also transmits position information measured by the positioning means to the assistance system 100. Time information is associated with the transmitted image, and the position where the image was captured can be identified by checking the time information against the position information. Before transmitting the image, a process of associating the position information with the image to be transmitted may be performed at the patrol vehicle 300 side.

The image collection unit 103 cuts out a site image from the image captured by the patrol vehicle 300 as described above and sends the cut-out site image to the matching unit 104. Although not illustrated in the example in FIG. 6, a storage device that retains the image received from the patrol vehicle 300 for a certain period may be provided.

Based on a utility pole image included in the site images and utility pole information recorded in a utility pole management ledger 200 of the customer, the matching unit 104 identifies the utility pole in the utility pole management ledger relevant to the utility pole captured by the patrol vehicle 300. The process of identifying the utility pole can be implemented, for example, by checking position information (latitude and longitude) on a utility pole recorded in the utility pole management ledger of the customer against imaging position information attached to a site image. In a case where the two positions are close to each other as a result of the check, the matching unit 104 determines that the utility pole included in the site image is the utility pole in the utility pole management ledger. The method for determining the identity between the utility poles is not limited to this method. For example, a feature of an image of a utility pole captured in advance may be compared with a feature of an image of a utility pole appearing in a site image collected by the image collection unit 13, and the identity between the two utility poles may be verified based on the identity between their shapes, the utility pole numbers obtained by character recognition, or the like. Finally, the matching unit 104 sends a combination of the site image and the content of the utility pole management ledger to the utility pole information provision unit 105. At this time, the matching unit 104 may send, to the utility pole information provision unit 105, a plurality of images sent from the patrol vehicle 300 in a relevant manner to utility poles in the utility pole management ledger.

The utility pole information provision unit 105 configures the utility pole management DB 201 obtained by adding the image of a utility pole captured by the moving object to data of the utility pole management ledger 20 of the customer, using the information identified by the matching unit 104. In a case where a plurality of images has been sent from the matching unit 104 for one utility pole in the utility pole management ledger, the utility pole information provision unit 105 adds this plurality of images to the utility pole management database. In this manner, the images of utility poles registered in the utility pole management database can be enriched. The utility pole information provision unit 105 provides utility pole information with the site image in response to a request from the terminal T of the worker.

In the example in FIG. 6, the description has been given assuming that the utility pole management ledger 200 is held at the customer side, but the utility pole management ledger 200 may be placed on a cloud infrastructure or at the utility pole management system 100b side. Apart from a form in which the utility pole management DB 201 is placed at the utility pole management system 100b side, a form in which the utility pole management DB 201 is placed on a cloud infrastructure can also be adopted.

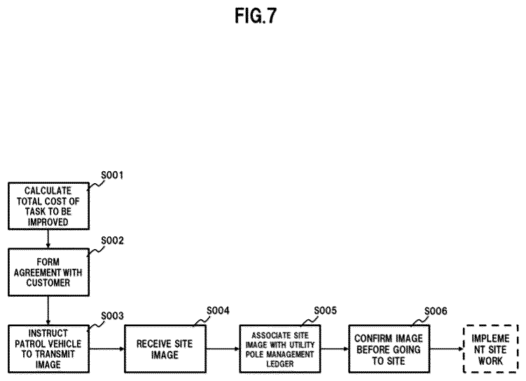

Subsequently, an overall operation of the present example embodiment will be described in detail with reference to the drawings. FIG. 7 is a diagram representing an overall operation of a configuration. Referring to FIG. 7, first, the estimation server 100a analyzes the task to be improved, based on information acquired from the customer, and calculates a total cost of the task to be improved (step S001).

Next, the estimation server 100a presents an improvement amount achieved by automation of the site image collection task to the customer and forms an agreement with the customer (step S002).

After formation of the agreement with the customer, service preparation by the utility pole management system 100b is started. Specifically, the patrol vehicle 300 is instructed to transmit the captured image to the utility pole management system 100b (step S003). The instruction to transmit the image to the utility pole management system 100b may not be explicit. For example, authentication information necessary for transmitting the image to the utility pole management system 100b, information on a consideration for the provision of the image, and the like may be transmitted to a passenger of the patrol vehicle 300. In this case, the vehicles that can participate in the present system as the patrol vehicle 300 can be expanded to the vehicle of a user who has received the authentication information, instead of a particular fixed vehicle.

Thereafter, the utility pole management system 100b receives the site image from the patrol vehicle 300 (step S004). Then, the utility pole management system 100b associates the received site image with the utility pole management ledger and updates the utility pole management DB 201 (step S005).

Before going to the site, the worker of the customer accesses the utility pole management system 100b, using the terminal T, and confirms an image of the site and the like (step S006). Then, the worker of the customer confirms the situation of the site and the state of the utility pole and then visits the site to implement the site work.

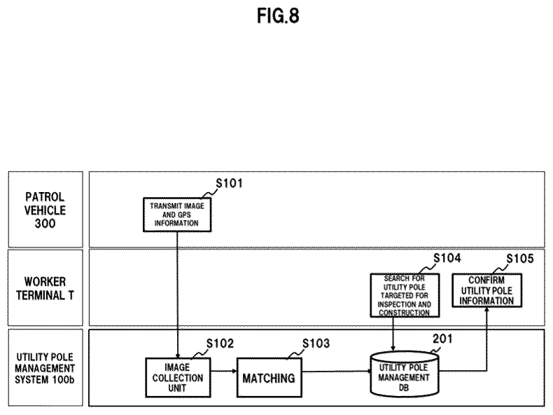

FIG. 8 is a diagram for explaining a detailed operation in steps S004 and S005 in FIG. 7. In the example in FIG. 8, GPS information is used as the position information. As described above, the patrol vehicle 300 travels along a preset course or the like and captures a surrounding image, using the mounted camera. Then, the patrol vehicle 300 transmits the image and the position information (GPS information) to the utility pole management system 100b while the traveling is ongoing or after the traveling is completed (step S101).

The image and the position information (GPS information) transmitted from the patrol vehicle 300 are received by the image collection unit 103 of the utility pole management system 100b (step S101). Then, the utility pole management system 100b performs matching between the received site image and data in the utility pole management ledger and updates the utility pole management DB 201 (step S103).

Meanwhile, before going to the site, the worker of the customer accesses the utility pole management system 100b, using the terminal T, and searches for a utility pole targeted for inspection and construction (step S104). The utility pole management system 100b searches the utility pole management DB 201 and transmits information including an image of the utility pole satisfying the search, to the terminal T. The worker of the customer confirms the content of the utility pole information including the image of the utility pole, which has been received from the utility pole management system 100b (step S105).

As described above, according to the present example embodiment, it is possible to lessen work required for preliminary inspection of a site and confirmation of a state of a utility pole, which have occupied a large weight in the utility pole management task of the customer. According to the present example embodiment, since the worker can make an appropriate preparation by viewing the site image, a situation of work can also be prevented from becoming difficult due to shortage of rigs and tools, delay in arrangement to other cooperating companies, or the like. For example, in a case where the periphery of the utility pole is covered with branches of neighboring trees, the worker of the customer is allowed to visit the site after preparing pruning shears or the like or asking a tree pruning company or the like to prune trees. Depending on the contribution rate when finding the improvement amount to be presented to the customer in step S002, it is expected that the sum of these benefits offered to the customer will exceed the improvement amount. The reason for this is that, in addition to using the number of utility poles and the inspection cost for these utility poles in the calculation of the improvement amount, the use of the assistance system 100 can prevent rework due to lack of preliminary inspection or occurrence of unintended additional work.

### Second Example Embodiment

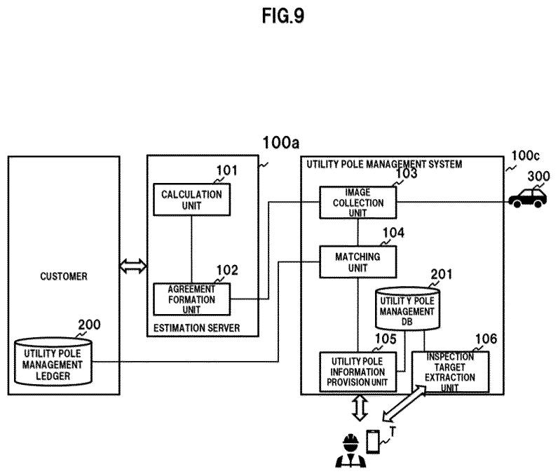

Subsequently, a description will be given of a second example embodiment in which a function of extracting an inspection target utility pole and notifying a customer of the extracted inspection target utility pole is added to the utility pole management system 100b. FIG. 9 is a diagram illustrating a detailed configuration of another assistance system of the present disclosure. A difference from the configuration example illustrated in FIG. 5 is that an inspection target extraction unit 106 is added to a utility pole management system 100c. Since the other part of the configuration is similar to the configuration in FIG. 5, the differences between the configurations will be mainly described below.

The inspection target extraction unit 106 extracts a utility pole that needs to be inspected, using the collected site images at a predetermined time interval X (second time interval), and notifies the customer of the extracted utility pole. The time interval X (second time interval) is desirably equal to or longer than a time interval (first time interval) at which a patrol vehicle 300 patrols target utility poles. The reason why the predetermined time interval X (second time interval) is made longer is that no change appears in the image unless the predetermined time interval is equal to or longer than the time interval at which the patrol vehicle 300 patrols target utility poles. More desirably, it is possible to adopt a form in which the inspection target extraction unit 106 extracts a utility pole that needs to be inspected at a timing when information in a utility pole management DB 201 is updated, that is, in synchronization with the patrol of the patrol vehicle 300. In this manner, it is possible to determine whether it is necessary to inspect each utility pole by using a latest site image added to the utility pole management DB 201.

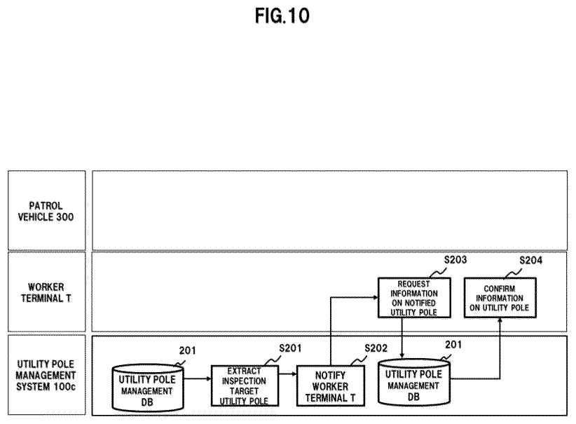

FIG. 10 is a diagram for explaining an additional operation of the utility pole management system 100b described above. As illustrated in FIG. 10, the utility pole management system 100b extracts a utility pole that needs to be inspected by using the collected site images at the predetermined time interval X (second time interval) (step S201).

Next, the utility pole management system 100b notifies the terminal T of the worker of the customer of the presence of the extracted inspection target utility pole (step S202).

The worker of the customer who has been notified accesses the utility pole management system 100b, using the terminal T, and requests information on the notified utility pole (step S203). The utility pole management system 100b searches the utility pole management DB 201 and transmits information including an image of the utility pole satisfying the search, to the terminal T. The worker of the customer confirms the content of the utility pole information including the image of the utility pole, which has been received from the utility pole management system 100b (step S204). Then, the worker of the customer starts preparation for the inspection task.

As described above, according to the present example embodiment, a plan for inspecting and updating a utility pole can be formulated using information accumulated in the utility pole management DB 201. Furthermore, when the inspection target utility pole is extracted, it is also preferable to narrow down utility poles that need to be inspected by machine learning in advance. This makes it possible to optimize the inspection cycle and cut down the cost required for the inspection.

Although each of the example embodiments of the present disclosure is described above, the present disclosure is not limited to the above-described example embodiments, and further modifications, substitutions, and adjustments can be made without departing from the basic technical idea of the present disclosure. For example, the network configuration, the configuration of each element, and the representation form of data that are illustrated in the drawings are merely examples that facilitate understanding of the present disclosure, and the present disclosure is not limited to those illustrated in the drawings.

For example, in the first and second example embodiments described above, it has been described assuming that the patrol vehicle 300 is used as the moving object, but the moving object may be an unmanned aerial vehicle, a public transportation vehicle, or the like.

In the first and second example embodiments described above, an example in which the target to be managed is a utility pole has been described, but the present disclosure can also be applied to inspection of facilities other than the utility pole. Examples of such facilities include road signs, manholes, traffic lights, electric signs, and machines installed on sidewalks or the like. That is, the present disclosure can also be applied to assistance in inspecting facilities other than the utility pole.

### Hardware Configuration

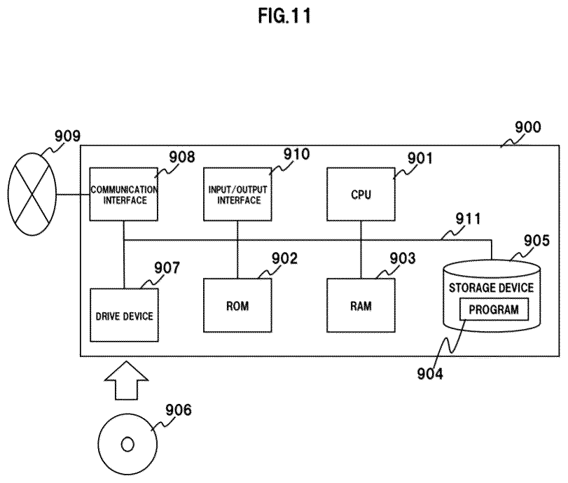

In each of the example embodiments of the present disclosure, each component of the apparatuses indicates a block of a functional unit. A part or all of the components of the apparatuses is achieved by, for example, any combination of an information processing apparatus 900 and a program, as illustrated in FIG. 11. FIG. 11 is a block diagram illustrating an example of a hardware configuration of the information processing apparatus 900 that achieves each component of each apparatus. The information processing apparatus 900 includes the following configuration as an example.
Central processing unit (CPU) 901
Read only memory (ROM) 902
Random access memory (RAM) 903
Program 904 loaded onto RAM 903
Storage device 905 that stores program 904
Drive device 907 that reads from and writes into recording medium 906
Communication interface 908 connected with communication network 909
Input/output interface 910 for inputting/outputting data
Bus 911 connecting between components

The components of the apparatuses in the example embodiments are achieved by the CPU 901 acquiring and executing the program 904 for achieving the functions. That is, the CPU 901 in FIG. 11 may execute a utility pole image matching program and a information provision program to perform update processing of calculation parameters stored in the RAM 903, the storage device 905, or the like. The program 904 for achieving the functions of the components of the apparatuses is stored in the storage device 905 or the ROM 902 in advance, for example, and is read by the CPU 901 as necessary. The program 904 may be supplied to the CPU 901 via the communication network 909, or may be stored in advance in the recording medium 906 to be read by the drive device 907 and supplied to the CPU 901.

Various modifications exist for the method of achieving the apparatuses. For example, the apparatuses may be achieved by any combination of the information processing apparatus 900 and individual programs for each component. A plurality of components included in the apparatuses may be achieved by any combination of one information processing apparatus 900 and one program. That is, units (processing means and functions) of a utility pole management task assistance system described in the first to third example embodiments may be achieved by a computer program that causes a processor mounted in the apparatus to execute the processing described above by using the hardware.

A part or all of the components of the apparatuses may be achieved by other general-purpose or dedicated circuits, processors, and the like, or a combination thereof. The circuits and the like may be configured by a single chip or may be configured by a plurality of chips connected to each other via a bus.

A part or all of the components of the apparatuses may be achieved by a combination of the above-described circuits and the like and a program.

When a part or all of the components of the apparatuses is achieved by a plurality of information processing apparatuses, circuits, and the like, the plurality of information processing apparatuses, circuits, and the like may be arranged to be centralized or to be distributed. For example, the information processing apparatus, the circuit, and the like may be achieved as a form such as a client and server system or a cloud computing system in which the apparatuses or the like are connected via a communication network.

The above-described example embodiments are preferred example embodiments of the present disclosure, and the scope of the present disclosure is not limited only to the above-described example embodiments. That is, it is possible for those skilled in the art to modify or substitute the above-described example embodiments and construct a mode in which various modifications are made without departing from the gist of the present disclosure.

A part or all of the above example embodiments may be described as the following Supplementary Notes, but are not limited to the following.

### Supplementary Note 1

A utility pole management task assistance method including:
calculating a total cost of a task to be improved, based on a number of utility poles located in a data collection target area and a cost required for confirming sites of the utility poles, these items of data being acquired from a customer who manages utility poles by using a utility pole management ledger;
multiplying the total cost by a predetermined contribution rate, calculating an improvement amount achieved by automation of a site image collection task, and presenting the improvement amount to the customer;
after formation of an agreement with the customer, implementing collection of site images by a moving object on which a camera is mounted;
based on a utility pole image included in the site images and utility pole information recorded in the utility pole management ledger of the customer, identifying a utility pole in the utility pole management ledger relevant to the utility pole image; and
configuring a utility pole management database obtained by adding the utility pole image captured by the moving object to data of the utility pole management ledger of the customer, and providing the obtained utility pole management database to the customer.

### Supplementary Note 2

The utility pole management task assistance method can adopt a form in which
position information is associated with the utility pole in the utility pole management ledger, and
the identifying includes identifying the utility pole in the utility pole management ledger relevant to the utility pole image by checking the position information against position information on the moving object.

### Supplementary Note 3

The utility pole management task assistance method can adopt a form further including
adjusting a value of the contribution rate according to a size of the data collection target area or a regional characteristic.

### Supplementary Note 4

The utility pole management task assistance method can adopt a form in which
the implementing includes causing the moving object to patrol at a first time interval and continuing the collection of the site images,
the form further including extracting a utility pole that needs to be inspected, at a second time interval, by using the collected site images, and notifying the customer of the extracted utility pole.

### Supplementary Note 5

The utility pole management task assistance method can adopt a form further including
adding a plurality of images around the utility poles captured by the moving object to the utility pole management database, as the site images.

### Supplementary Note 6

A utility pole management task assistance system including:
a calculation unit that calculates a total cost of a task to be improved, based on a number of utility poles located in a data collection target area and a cost required for confirming sites of the utility poles, these items of data being acquired from a customer who manages utility poles by using a utility pole management ledger;
an agreement formation unit that multiplies the total cost by a predetermined contribution rate, calculates an improvement amount achieved by automation of a site image collection task, presents the improvement amount to the customer, and forms an agreement with the customer;
an image collection unit that, after formation of the agreement with the customer, implements collection of site images by a moving object on which a camera is mounted;
a matching unit that, based on a utility pole image included in the site images and utility pole information recorded in the utility pole management ledger of the customer, identifies a utility pole in the utility pole management ledger relevant to the utility pole image; and
a utility pole information provision unit that configures a utility pole management database obtained by adding the utility pole image captured by the moving object to data of the utility pole management ledger of the customer, and provides the obtained utility pole management database to the customer.

### Supplementary Note 7

The utility pole management task assistance system can adopt a configuration in which position information is associated with the utility pole in the utility pole management ledger, and
the matching unit identifies the utility pole in the utility pole management ledger relevant to the utility pole image by checking the position information against position information on the moving object.

### Supplementary Note 8

The utility pole management task assistance system can adopt a configuration in which the agreement formation unit uses the contribution rate adjusted according to a size of the data collection target area or a regional characteristic.

### Supplementary Note 9

The utility pole management task assistance system can adopt a configuration in which
the image collection unit causes the moving object to patrol at a first time interval and continues the collection of the site images,
the utility pole management task assistance system further including
an inspection target notification unit that extracts a utility pole that needs to be inspected, at a second time interval, by using the collected site images, and notifies the customer of the extracted utility pole.

### Supplementary Note 10

The utility pole management task assistance system can adopt a configuration in which
a plurality of images around the utility poles captured by the moving object is added to the utility pole management database, as the site images.

The modes described in the above Supplementary Notes can be combined with each other after making necessary modifications. For example, a configuration having both the contents described in the Supplementary Note 2 and the contents described in the Supplementary Note 3 is also included in the disclosure range of the present specification.

The disclosures of each of the above PTLs is incorporated herein by reference, and may be used as the basis or a part of the present disclosure as necessary. Modifications and adjustments of the example embodiments or examples are possible within the scope of the overall disclosure (including the claims) of present disclosure and based on the basic technical concept of the present disclosure. Various combinations or selections (including partial deletions) of various disclosure elements (including the elements in each of the claims, example embodiments or examples, drawings, and the like) are possible within the scope of the present disclosure. That is, the present disclosure of course includes various variations and modifications that could be made by those skilled in the art in accordance with the technical concept. The description discloses numerical value ranges. However, even if the description does not particularly disclose any numerical values or sub-range included within the ranges, these values and ranges should be construed to have been concretely disclosed. Furthermore, the disclosures of the above-cited documents may be used, in part or in whole, in combination with the descriptions in this document, as part of this disclosure, in accordance with the gist of this disclosure, and such uses are deemed to be included in the disclosures of this application.

### REFERENCE SIGNS LIST

10, 100 utility pole management task assistance system
11, 101 calculation unit
12, 102 agreement formation unit
13, 103 image collection unit
14, 104 matching unit
15, 105 utility pole information provision unit
20, 200 utility pole management ledger
21, 201 utility pole management DB
100a estimation server
100b, 100c utility pole management system
106 inspection target extraction unit
300 patrol vehicle
900 information processing apparatus
901 central processing unit (CPU)
902 read only memory (ROM)
903 random access memory (RAM)
904 program
905 storage device
906 recording medium
907 drive device
908 communication interface
909 communication network
910 input/output interface
911 bus
T terminal

What is claimed is:

1. A utility pole management task assistance method comprising:
calculating a total cost of a task to be improved, by using at least a number of utility poles located in a data collection target area and a cost required for confirming sites of the utility poles, these items of data being acquired from a customer who manages utility poles by using a utility pole management ledger;
multiplying the total cost by a predetermined contribution rate, calculating an improvement amount achieved by automation of a site image collection task, and presenting the improvement amount to the customer;
after formation of an agreement with the customer, implementing collection of site images by a moving object on which a camera is mounted;
based on a utility pole image included in the site images and utility pole information recorded in the utility pole management ledger of the customer, identifying a utility pole in the utility pole management ledger relevant to the utility pole image; and
configuring a utility pole management database obtained by adding the utility pole image captured by the moving object to data of the utility pole management ledger of the customer, and providing the obtained utility pole management database to the customer.

2. The utility pole management task assistance method according to claim 1, wherein
position information is associated with the utility pole in the utility pole management ledger, and
the identifying includes identifying the utility pole in the utility pole management ledger relevant to the utility pole image by checking the position information against position information on the moving object.

3. The utility pole management task assistance method according to claim 1, further comprising adjusting a value of the contribution rate according to a size of the data collection target area or a regional characteristic.

4. The utility pole management task assistance method according to claim 1, wherein
the implementing includes causing the moving object to patrol at a first time interval and continuing the collection of the site images,
the utility pole management task assistance method further comprising extracting a utility pole that needs to be inspected, at a second time interval, by using the collected site images, and notifying the customer of the extracted utility pole.

5. The utility pole management task assistance method according to claim 1, further comprising adding a plurality of images around the utility poles captured by the moving object to the utility pole management database, as the site images.

6. A utility pole management task assistance system comprising:
a memory configured to store instructions; and
a processor configured to execute the instructions to:
calculate a total cost of a task to be improved, by using at least a number of utility poles located in a data collection target area and a cost required for confirming sites of the utility poles, these items of data being acquired from a customer who manages utility poles by using a utility pole management ledger;
multiply the total cost by a predetermined contribution rate, calculate an improvement amount achieved by automation of a site image collection task, present the improvement amount to the customer, and form an agreement with the customer;
implement collection of site images by a moving object on which a camera is mounted after formation of the agreement with the customer;
identifies a utility pole in the utility pole management ledger relevant to the utility pole image based on a utility pole image included in the site images and utility pole information recorded in the utility pole management ledger of the customer; and
configure a utility pole management database obtained by adding the utility pole image captured by the moving object to data of the utility pole management ledger of the customer, and provide the obtained utility pole management database to the customer.

7. The utility pole management task assistance system according to claim 6, wherein
position information is associated with the utility pole in the utility pole management ledger, and
the processor identifies the utility pole in the utility pole management ledger relevant to the utility pole image by checking the position information against position information on the moving object.

8. The utility pole management task assistance system according to claim 6, wherein the processor uses the contribution rate adjusted according to a size of the data collection target area or a regional characteristic.

9. The utility pole management task assistance system according to claim 6, wherein
the processor causes the moving object to patrol at a first time interval and continues the collection of the site images,
the processor further configured to execute the instructions to extracts a utility pole that needs to be inspected, at a second time interval, by using the collected site images, and notify the customer of the extracted utility pole.

10. The utility pole management task assistance system according to claim 6, wherein a plurality of images around the utility poles captured by the moving object is added to the utility pole management database, as the site images.

11. The utility pole management task assistance system according to claim 7, wherein the processor uses the contribution rate adjusted according to a size of the data collection target area or a regional characteristic.

12. The utility pole management task assistance system according to claim 7, wherein
the processor causes the moving object to patrol at a first time interval and continues the collection of the site images,
the processor further configured to execute the instructions to extracts a utility pole that needs to be inspected, at a second time interval, by using the collected site images, and notify the customer of the extracted utility pole.

13. The utility pole management task assistance system according to claim 8, wherein
the processor causes the moving object to patrol at a first time interval and continues the collection of the site images,
the processor further configured to execute the instructions to extracts a utility pole that needs to be inspected, at a second time interval, by using the collected site images, and notify the customer of the extracted utility pole.

14. The utility pole management task assistance system according to claim 7, wherein a plurality of images around the utility poles captured by the moving object is added to the utility pole management database, as the site images.

15. The utility pole management task assistance system according to claim 8, wherein a plurality of images around the utility poles captured by the moving object is added to the utility pole management database, as the site images.

16. The utility pole management task assistance system according to claim 9, wherein a plurality of images around the utility poles captured by the moving object is added to the utility pole management database, as the site images.

17. The utility pole management task assistance method according to claim 2, further comprising adjusting a value of the contribution rate according to a size of the data collection target area or a regional characteristic.

18. The utility pole management task assistance method according to claim 2, wherein
the implementing includes causing the moving object to patrol at a first time interval and continuing the collection of the site images,
the utility pole management task assistance method further comprising extracting a utility pole that needs to be inspected, at a second time interval, by using the collected site images, and notifying the customer of the extracted utility pole.

19. The utility pole management task assistance method according to claim 3, wherein
the implementing includes causing the moving object to patrol at a first time interval and continuing the collection of the site images,
the utility pole management task assistance method further comprising extracting a utility pole that needs to be inspected, at a second time interval, by using the collected site images, and notifying the customer of the extracted utility pole.

20. The utility pole management task assistance method according to claim 2, further comprising adding a plurality of images around the utility poles captured by the moving object to the utility pole management database, as the site images.
